(19) United States
(12) Patent Application Publication
(10) Pub. No.: US 2016/0173831 A1
(43) Pub. Date: Jun. 16, 2016

(54) LANE BOUNDARY LINE RECOGNITION APPARATUS

(71) Applicant: DENSO CORPORATION, Kariya-city (JP)

(72) Inventors: Yusuke Akamine, Nishio-shi (JP); Naoki Kawasaki, Kariya-shi (JP); Shunsuke Suzuki, Nukata-gun (JP)

(21) Appl. No.: 14/964,131

(22) Filed: Dec. 9, 2015

(30) Foreign Application Priority Data
Dec. 10, 2014 (JP) 2014-249894

(51) Int. Cl. H04N 7/18; G06T 7/00; G06K 9/00

(52) U.S. Cl. CPC H04N 7/185; G06K 9/00798; G06K 9/00805; G06T 7/0085; G06T 2207/30256; G06T 2207/30261; G06T 2207/30241; G06T 2207/30236

(57) ABSTRACT

A lane boundary line recognition apparatus, mounted to an own vehicle, images a road surface ahead of the own vehicle and acquires an image. Edge points are extracted from the image. A lane boundary line candidate is extracted based the edge points. A lane boundary line probability of the lane boundary line candidate is calculated. A lane boundary line candidate of which the lane boundary line probability exceeds a predetermined threshold is recognized as a lane boundary line. A solid object is recognized in an image. A lane boundary line being hidden by the solid object is detected. When a lane boundary line being hidden is detected, the lane boundary line probability is suppressed in at least a part of an area outside of the hidden lane boundary line, compared to that when the lane boundary line being hidden is not detected.

### CROSS-REFERENCE TO RELATED APPLICATION

This application is based on and claims the benefit of priority from Japanese Patent Application No. 2014-249894, filed Dec. 10, 2014. The entire disclosure of the above application is incorporated herein by reference.

### BACKGROUND

1. Technical Field

The present disclosure relates to a lane boundary line recognition apparatus.

2. Related Art

Conventionally, a technology is known in which a road surface ahead of an own vehicle is imaged and an image is acquired. A lane boundary line (lane marking such as a white line) is recognized from the image.

A solid object, such as a preceding vehicle, may be present ahead of the own vehicle. The solid object may hide the lane boundary line. In this case, the lane boundary line may not be accurately recognized. Therefore, a technology is proposed in which the area of a preceding vehicle is excluded from the image, and the lane boundary line is recognized from the image after the exclusion (refer to JP-A-H07-117523).

When the preceding vehicle and the own vehicle are near each other, the lane boundary line that appears in the image after exclusion of the area of the preceding vehicle is minimal. In this case, the actual lane boundary line may not be recognized. Rather, a peripheral object may be erroneously recognized as the lane boundary line.

### SUMMARY

It is thus desired to provide a lane boundary line recognition apparatus that is capable of solving the above-described issues.

An exemplary embodiment provides a lane boundary line recognition apparatus that includes an image acquiring unit, an edge point extracting unit, a lane boundary line candidate detecting unit, a lane boundary line probability calculating unit, and a lane boundary line recognizing unit. The image acquiring unit images a road surface ahead of an own vehicle and acquires an image. The edge point extracting unit extracts edge points from the image. The lane boundary line candidate extracting unit extracts a lane boundary line candidate based on the edge points. The lane boundary line probability calculating unit calculates a lane boundary line probability of the lane boundary line candidate. The lane boundary line recognizing unit recognizes a lane boundary line candidate of which the lane boundary line probability exceeds a predetermined threshold as a lane boundary line.

In the exemplary embodiment, the lane boundary line recognition apparatus further includes a solid object recognizing unit, a hidden state detecting unit, and a lane boundary line probability correcting unit. The solid object recognizing unit recognizes a solid object in an image. The hidden state detecting unit detects a lane boundary line being hidden by the solid object. When the lane boundary line being hidden by the solid object is detected, the lane boundary line probability correcting unit suppresses the lane boundary line probability in at least part of an area outside of a hidden lane boundary line, compared to that when the lane boundary line being hidden by the solid object is not detected.

According to the exemplary embodiment, the lane boundary line recognition apparatus suppresses the lane boundary line probability in at least part of an area outside of a hidden lane boundary line, compared to that when the hidden state is not detected. Therefore, erroneous recognition of an object (such as the shoulder of a road) outside of a hidden lane boundary line as a lane boundary line can be suppressed.

### BRIEF DESCRIPTION OF THE DRAWINGS

In the accompanying drawings:

FIG. 1 is a block diagram of a configuration of a lane boundary line recognition apparatus according to a first embodiment;

FIG. 2 is an explanatory diagram of the placement of a camera in an own vehicle;

FIG. 3 is a flowchart of a lane boundary line recognition process performed by the lane boundary line recognition apparatus;

FIG. 4 is a flowchart of a correction setting process performed by the lane boundary line recognition apparatus;

FIG. 5 is an explanatory diagram of a state in which lane boundary lines are hidden by a solid object in an image;

FIG. 6 is an explanatory diagram of a display object and regions displayed on a display; and

FIG. 7 is an explanatory diagram of areas including hidden lines.

### DESCRIPTION OF THE EMBODIMENTS

An embodiment of the present disclosure will be described with reference to the drawings.

### First Embodiment

### 1. Configuration

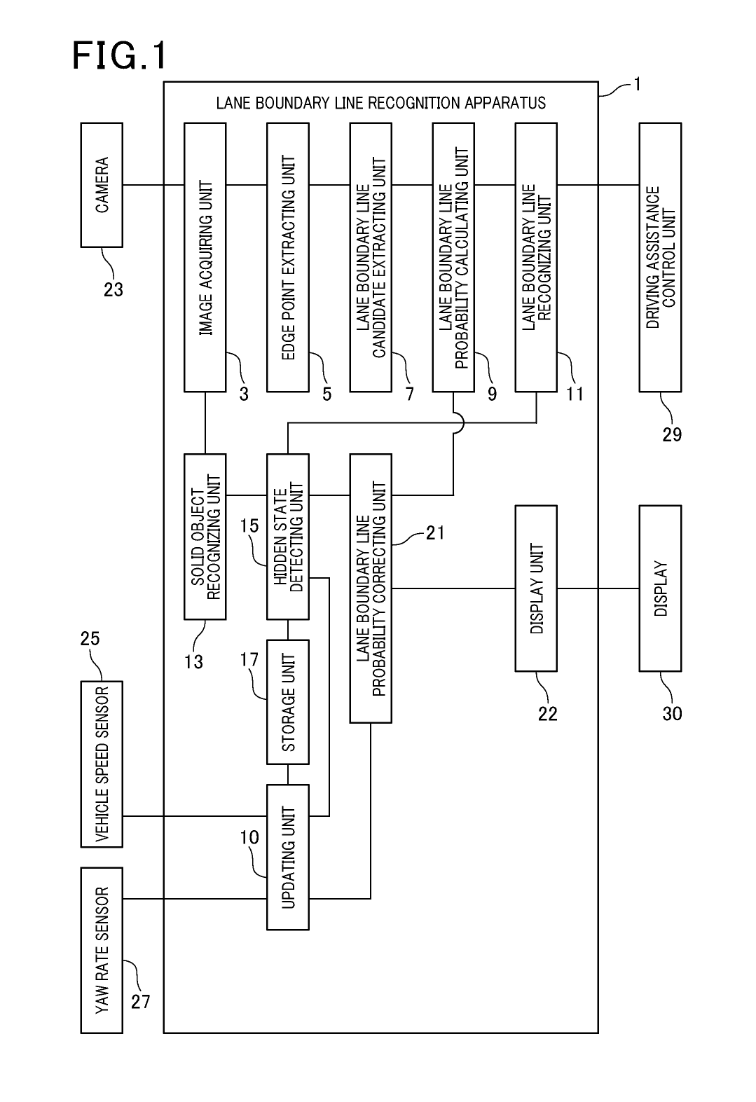

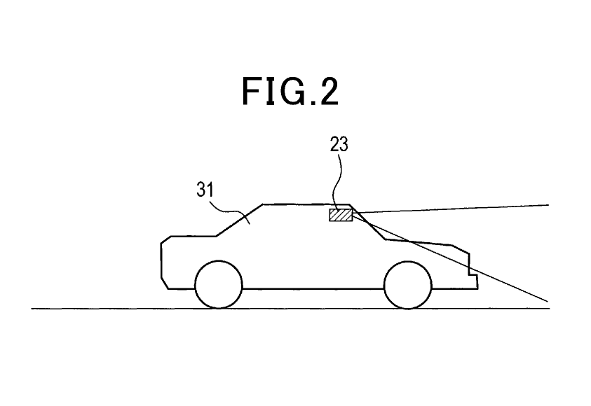

A configuration of a lane boundary line recognition apparatus 1 will be described with reference to FIG. 1 and FIG. 2. The lane boundary line recognition apparatus 1 is an on-board apparatus that is mounted in a vehicle. The vehicle in which the lane boundary line recognition apparatus 1 is mounted is referred to, hereafter, as an own vehicle 31. The lane boundary line recognition apparatus 1 is a known computer that includes a central processing unit (CPU), a random access memory (RAM), a read-only memory (ROM), and the like. The lane boundary line recognition apparatus 1 performs processes, described hereafter, based on programs stored in the ROM.

As shown in FIG. 1, the lane boundary line recognition apparatus 1 is functionally provided with an image acquiring unit 3, an edge point extracting unit 5, a lane boundary line candidate extracting unit 7, a lane boundary line probability calculating unit 9, a lane boundary line recognizing unit 11, a solid object recognizing unit 13, a hidden state detecting unit 15, a storage unit 17, an updating unit 19, a lane boundary line probability correcting unit 21, and a display unit 22. The functions of the units will be described hereafter.

In addition to the lane boundary line recognition apparatus 1, the own vehicle 31 includes a camera 23, a vehicle speed sensor 25, a yaw rate sensor 27, a driving assistance control unit 29, and a display 30. As shown in FIG. 2, the camera 23 is attached to the front side, inside the cabin of the own vehicle 31. The camera 23 images the area ahead of the own vehicle 31 and generates an image. The road ahead of the own vehicle 31 is included in the angle of view of the generated image. Hereafter, a single image generated by the camera may be referred to as a single frame. When the on-board camera 23 successively generates frames F₁, F₂, F₃ . . . , frame F₁ is one frame before frame F₂. Frame F₃ is one frame after F₂.

The vehicle speed sensor 25 detects the vehicle speed of the own vehicle 31. The yaw rate sensor 27 detects the yaw rate of the own vehicle 31. The driving assistance control unit 29 performs driving assistance processes, such as lane keep assist, using the lane boundary lines recognized by the lane boundary line recognition apparatus 1. The display 30 is a liquid crystal display that is set inside the cabin of the own vehicle 31 and is capable of displaying various images.

### 2. Lane Boundary Line Recognition Process

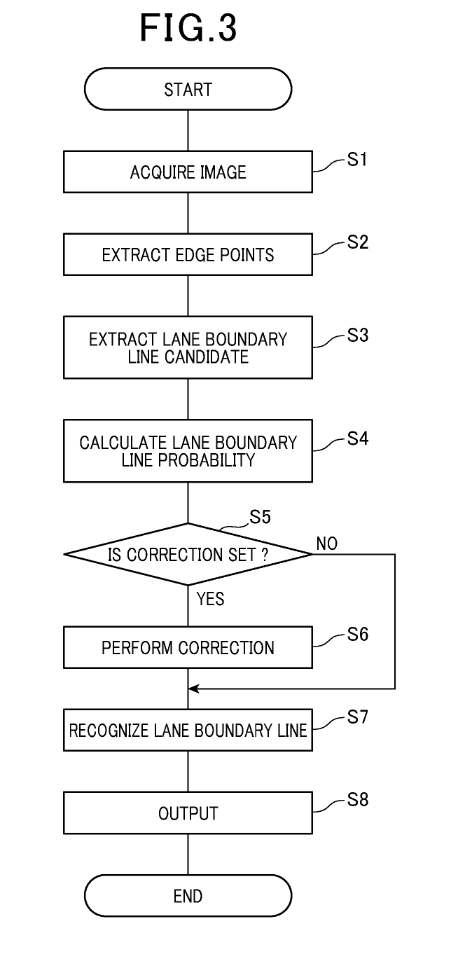

A lane boundary line recognition process repeatedly performed at a predetermined time interval by the lane boundary line recognition apparatus 1 will be described with reference to FIG. 3.

At step S1 in FIG. 3, the image acquiring unit 3 acquires an image (a single frame) from the camera 23.

At step S2, the edge point extracting unit 5 extracts edge points from the image acquired at step S1. Specifically, first, the edge point extracting unit 5 calculates a differential value using a differential filter, for each horizontal line (all pixels having equal coordinate values in the vertical direction) in the image. That is, the edge point extracting unit 5 calculates the rate of change in luminance value between adjacent pixels for a plurality of pixels configuring the horizontal line.

Next, the edge point extracting unit 5 determines whether or not the calculated differential value is a predetermined upper limit value or higher. When determined that the differential value is the upper limit value or higher, the luminance value between adjacent pixels is considered to have significantly changed. Therefore, the edge point extracting unit 5 extracts the coordinate values of the pixel as an edge point and registers the edge point. The edge point extracting unit 5 performs the above-described process on all pixels in the image.

At step S3, the lane boundary line candidate extracting unit 7 extracts a lane boundary line candidate based on the edge points extracted at step S2. Extraction of the lane boundary line candidate can be performed by a known Hough transform process for line extraction or the like. A plurality of lane boundary line candidates may be detected in a single image frame.

At step S4, the lane boundary line probability calculating unit 9 calculates the lane boundary line probability (likelihood) of the lane boundary line candidate extracted at step S3. The lane boundary line probability can be calculated by a known method. For example, a lane boundary line probability value can be calculated for each of the following items: the number of edge points configuring the lane boundary line candidate, the shape of the lane boundary line candidate, the relative position of the lane boundary line candidate in relation to another object, and the like. A value obtained by multiplication of the calculated lane boundary line probability values can be set as the final lane boundary line probability.

At step S5, the lane boundary line probability correcting unit 21 determines whether or not a correction of some kind is set by a correction setting process, described hereafter. When determined that a correction of some kind is set, the lane boundary line recognition apparatus 1 proceeds to step S6. When determined that no correction is set, the lane boundary line recognition apparatus 1 proceeds to step S7.

At step S6, the lane boundary line probability correcting unit 21 corrects the lane boundary line probability calculated at step S4. The content of the correction is a first correction or a second correction, set by the correction setting process, described hereafter. Details will be described hereafter.

At step S7, the lane boundary line recognizing unit 11 compares the lane boundary line probability to a predetermined threshold that has been set in advance. The lane boundary line probability that is compared is the lane boundary line probability after correction, if correction is performed at step S6. When correction is not performed at step S6, the lane boundary line probability that is compared is the lane boundary line probability itself calculated at step S4. Among the lane boundary line candidates, a lane boundary line candidate of which the lane boundary line probability exceeds the threshold is recognized as a lane boundary line.

At step S8, the lane boundary line recognizing unit 11 outputs the lane boundary line recognized at step S7 to the driving assistance control unit 29.

3. Correction Setting Process performed by the Lane Boundary Line Recognition Apparatus 1.

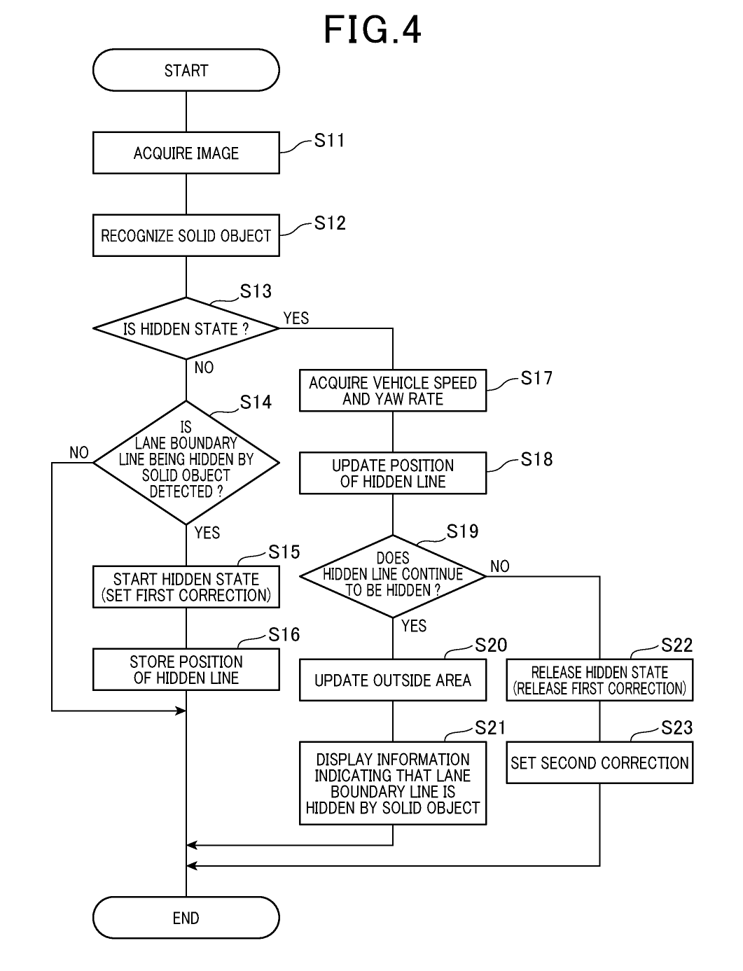

The correction setting process repeatedly performed at a predetermined time interval by the lane boundary line recognition apparatus 1 will be described with reference to FIG. 4 to FIG. 7. The correction setting process is a process for setting the correction performed at step S6.

At step S11 in FIG. 4, the image acquiring unit 3 acquires an image from the camera 23.

At step S12, the solid object recognizing unit 13 performs a process for recognizing a solid object from the image acquired at step S11. The solid object recognition can be performed by a known image recognition technique. The solid object to be recognized includes, for example, a preceding vehicle.

At step S13, the hidden state detecting unit 15 detects whether or not a hidden state is currently occurring. The hidden state is a state that starts at step S15, described hereafter, and is released at step S22, described hereafter. The content of the hidden state will be described hereafter.

When determined that the hidden state is not currently occurring, the lane boundary line recognition apparatus 1 proceeds to step S14. When determined that the hidden state is occurring, the lane boundary line recognition apparatus 1 proceeds to step S17.

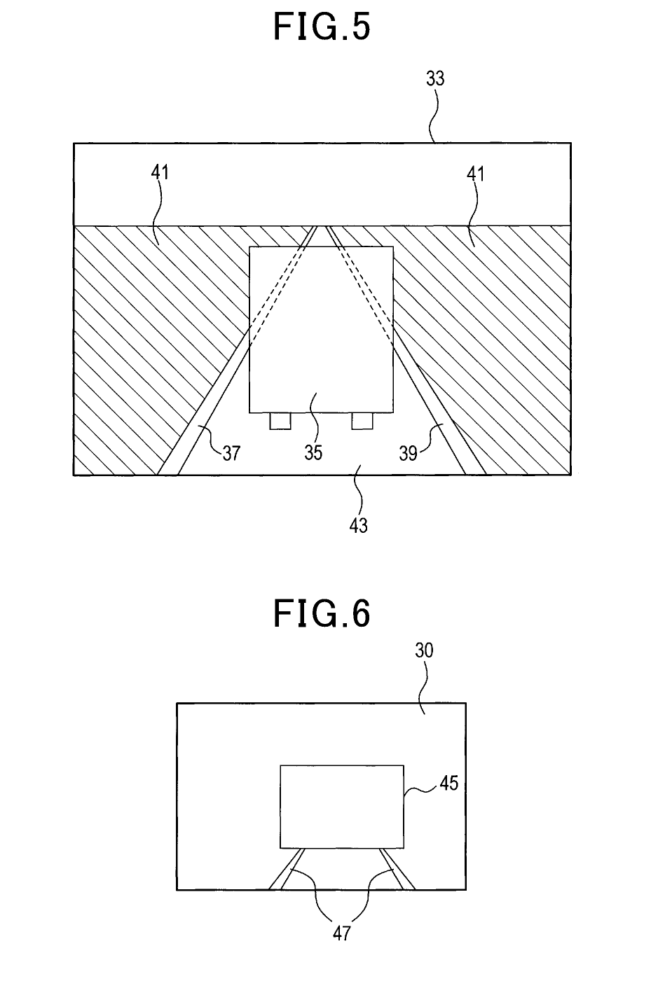

At step S14, the hidden state detecting unit 15 determines whether or not a lane boundary line is hidden by a solid object. The lane boundary line to be subjected to the determination is a lane boundary line that has been recognized by the lane boundary line recognition process performed on one frame before the image acquired at step S11. For example, as shown in FIG. 5, when a solid object 35 overlaps at least a part of the lane boundary lines 37 and 39 in an image 33 acquired at step S11, the hidden state detecting unit 15 determines that the lane boundary lines 37 and 39 are hidden and proceeds to step S15.

Meanwhile, when determined that a solid object is not recognized at step S12, or when determined that the solid object recognized at step S12 does not overlap the lane boundary lines 37 and 39, the hidden state detecting unit 15 determines that the lane boundary lines 37 and 39 are not hidden and ends the present process.

At step S15, the lane boundary line probability correcting unit 21 starts the hidden state. The lane boundary line probability correcting unit 21 sets a correction (referred to, hereafter, as the first correction) to suppress lane boundary line probability as the correction performed at step S6, described above. Therefore, when the process at step S6 is performed in the hidden state, the first correction is performed.

The content of the first correction is as follows. As shown in FIG. 5, in the image 33 acquired at step S11, with reference to a lane 43 in which the own vehicle 31 is traveling, the areas outside of the lane boundary lines 37 and 39 are referred to as outside areas 41. The lane boundary lines 37 and 39 have been recognized in a frame that is one frame before the frame acquired at step S11.

The first correction is a correction in which the lane boundary line probability of a lane boundary line candidate that is in the outside area 41 is suppressed (the value is reduced) in relation to the value calculated at step S4. A method for suppressing the lane boundary line probability includes, for example, a method in which the lane boundary line probability before correction is multiplied by a coefficient that is 0 or greater and less than 1. When the coefficient is 0, the lane boundary line probability after the first correction can be set to 0. In addition, a method in which a fixed value is subtracted from the lane boundary line probability before correction can be given as another method.

When the first correction is not set, the lane boundary line probability of the lane boundary line candidate in the outside area 41 is not corrected at step S6, and remains set to the value calculated at step S4. Therefore, when a lane boundary line being hidden is detected at step S14 and a hidden state starts, the lane boundary line probability of the lane boundary line candidate that is in the outside area 41 is suppressed compared to when the hidden state has not occurred.

Returning to FIG. 4, at step S16, the lane boundary line recognition apparatus 1 stores the position of the lane boundary line that has been determined to be hidden by the solid object at step S14 (hereinafter referred to as a hidden line) in the storage unit 17.

When determined that the hidden state is occurring at step S13, the lane boundary line recognition apparatus 1 proceeds to step S17. The updating unit 19 acquires the vehicle speed of the own vehicle 31 using the vehicle speed sensor 25 and acquires the yaw rate of the own vehicle 31 using the yaw rate sensor 27.

At step S18, the updating unit 19 updates the position of the hidden line stored at step S16 (the hidden line after updating, if an update has already been performed) using the vehicle speed and yaw rate acquired at step S17. That is, the position of the same hidden line, viewed from the own vehicle 31, changes in accompaniment with the traveling of the own vehicle 31. Therefore, the stored position of the hidden line is updated to a position in which the hidden line should be present in the newest image.

At step S19, the hidden state detecting unit 15 compares the position of the hidden 1line updated at step S18 and the position of the solid object recognized at step S12. The hidden state detecting unit 15 determines whether or not the hidden line is hidden by the solid object. When determined that the hidden line being hidden by the solid object (that is, the hidden line continues to be hidden), the hidden state detecting unit 15 proceeds to step S20. When determined that the hidden line is not hidden by the solid object, the hidden state detecting unit 15 proceeds to step S22.

At step S20, the lane boundary line probability correcting unit 21 updates the positon of the outside area based on the position of the hidden line updated at step S18. That is, the outside area is set to be an area outside of the hidden line updated at step S18. The area over which the lane boundary line probability is suppressed by the first correction is the updated outside area.

At step S21, as shown in FIG. 6, the display unit 22 displays a display object 45 in the display 30. The display object 45 indicates that the lane boundary line is hidden. The display object 45 is displayed when the hidden state is occurring, and is not displayed otherwise. That is, the display object 45 is a display corresponding to when the lane boundary line is hidden.

In addition, when a hidden line is not recognized in the lane boundary line recognition process, the display unit 22 performs display indicating this result in the display 30. As shown in FIG. 6, the display is that in which a region 47 indicating a lane boundary line flashes. Flashing of the region 47 is performed when a hidden line is not recognized, and is not performed otherwise. That is, flashing of the region 47 is a display aspect that corresponds to when a hidden line is not recognized. A hidden line not being recognized in the lane boundary line recognition process indicates that a lane boundary line is not recognized in a position coinciding with the hidden line.

When determined NO at step S19, the lane boundary line recognition apparatus 1 proceeds to step S22. The hidden state temporarily occurring and then, subsequently, a determination being made that the hidden line is not hidden at step S19 is an example of when the hidden state is temporarily detected and subsequently not detected. At step S22, the lane boundary line probability correcting unit 21 releases the hidden state. When the hidden state is released, the first correction setting is released. From this time onward, the first correction is no longer performed at step S6.

At step S23, the lane boundary line recognition apparatus 1 sets the second correction. When step S6 is performed from this time onward, the second correction is performed at step S6.

The second correction is a correction in which the lane boundary line probability is increased in an area including the hidden line. A method for increasing the lane boundary line probability includes, for example, a method in which the lane boundary line probability before correction is multiplied by a coefficient that is greater than 1. A method in which a fixed value is added to the lane boundary line probability before correction is given as another method.

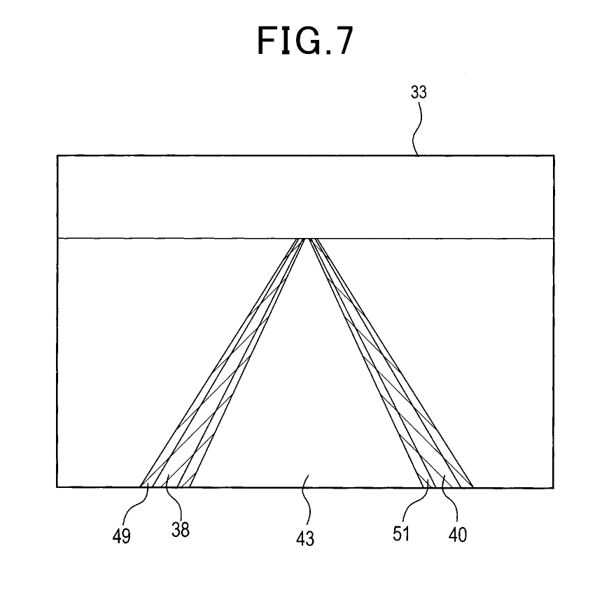

For example, as shown in FIG. 7, the area including the hidden line is an area 49 that includes the position of a hidden line 38 and spreads to both sides of the hidden line 38 by a predetermined amount. The area including the hidden line is also an area 51 that includes the position of a hidden line 40 and spreads to both sides of the hidden line 40 by a predetermined amount. Here, the positions of the hidden lines 38 and 40 are positions that have been updated at step S18.

When the second correction is not set, the second correction is not performed at step S6. The lane boundary line probability in the area including the hidden line remains set to the value calculated at step S4. Therefore, when the second correction is set, the lane boundary line probability in the area including the hidden line increases, compared to that when the second correction is not set.

The second correction is set until a lane boundary line is recognized in the area including the hidden line. The setting is released after the lane boundary line is recognized.

### 4. Effects

(1A) When a lane boundary line being hidden by a solid object is detected, the lane boundary line recognition apparatus 1 suppresses the lane boundary line probability in the outside area, compared to that when it is not detected that a lane boundary line is hidden by a solid object (sets the first correction). As a result, even when the lane boundary line is hidden by the solid object, erroneous recognition of an object (such as the shoulder of the road) in the outside area as a lane boundary line can be suppressed.

(1B) When a lane boundary line being hidden by a solid object is temporarily detected and a hidden state is started, and subsequently, the hidden state is no longer detected and the hidden state is released, the lane boundary line recognition apparatus 1 releases the suppression of the lane boundary line probability in the outside area (releases the first correction setting). As a result, the lane boundary line can be appropriately recognized in a state in which the lane boundary line is not hidden.

(1C) When a lane boundary line being hidden by a solid object is temporarily detected and a hidden state is started, and subsequently, the hidden state is no longer detected and the hidden state is released, the lane boundary line recognition apparatus 1 increases the lane boundary line probability in the area including the hidden line, compared to that when a hidden state has not been detected even once (sets the second correction). As a result, a lane boundary line that has been hidden up to this point and could not be recognized can be promptly recognized after the lane boundary line is not hidden.

(1D) The lane boundary line recognition apparatus 1 stores the position of a hidden line and updates the position of the hidden line based on the vehicle speed and the yaw rate of the own vehicle. The area including the hidden line is set based on the position of the hidden line updated as described above. Therefore, the area including the hidden line can be accurately set. As a result, the lane boundary line in the area including the hidden line can be easily recognized.

(1E) When a lane boundary line being hidden by a solid object is detected, the lane boundary line recognition apparatus 1 performs display corresponding to this case. As a result, the driver of the own vehicle is able to easily know that the lane boundary line is being hidden.

(1F) When a hidden line cannot be recognized, the lane boundary line recognition apparatus 1 performs display corresponding to this case. As a result, the driver of the own vehicle is able to easily know that the lane boundary line cannot be recognized because the lane boundary line is hidden by a solid object.

### Other Embodiments

An embodiment of the present disclosure is described above. However, the preset disclosure is not limited to the above-described embodiment. Various embodiments are possible.

(1) In the hidden state, the lane boundary line recognition apparatus 1 may change the calculation condition for the lane boundary line probability calculating unit 9. For example, the lane boundary line probability calculation condition can be changed such that the lane boundary line probability is reduced in the outside area when the hidden state is occurring, compared to when the hidden state is not occurring.

In addition, when the hidden state is released at step S22, the lane boundary line recognition apparatus 1 may change the calculation condition for the lane boundary line probability calculating unit 9. For example, the lane boundary line probability calculation condition can be changed such that the lane boundary line probability in the area including the hidden line increases when the hidden state is released at step S22, compared to when the hidden state is not released.

(2) The lane boundary line probability recognition apparatus 1 may start the correction setting process under a condition that a solid object has been detected by a detecting means, such as a laser radar.

(3) The outside area may be part of, or the entirety of, the area outside of the lane boundary lines.

(4) In a state in which the hidden state continues for a predetermined amount of time or longer, or in a state in which the lane boundary line (such as a white line) is substantially not visible because of a solid object, in addition to the correction process according to the above-described embodiment, lane boundary line recognition may be terminated. The user may be notified of the termination.

(5) A function provided by a single constituent element according to the above-described embodiments may be dispersed among a plurality of constituent elements. Functions provided by a plurality of constituent elements may be integrated in a single constituent element. In addition, at least some of the configurations according to the above-described embodiments may be replaced with publically known configurations that provide similar functions. Furthermore, at least some of the configurations according to the above-described embodiments may be omitted. Moreover, at least some of the configurations according to the above-described embodiments may, for example, be added to or substituted for a configuration according to another of the above-described embodiments. Any embodiment included in the technical concept specified only by the wordings of the scope of claims is an embodiment of the present disclosure.

The present disclosure can also be actualized by various modes in addition to the above-described lane boundary line recognition apparatus, such as a system of which a constituent element is the lane boundary line recognition apparatus, a program enabling a computer to function as the lane boundary line recognition apparatus, a recording medium on which the program is recorded, and a lane boundary line recognition method.

What is claimed is:

1. A lane boundary line recognition apparatus that is mounted to an own vehicle, the lane boundary line recognition apparatus comprising:
an image acquiring unit that images a road surface ahead of the own vehicle and acquires an image;
an edge point extracting unit that extracts edge points from the image;
a lane boundary line candidate extracting unit that extracts a lane boundary line candidate based on the edge points;
a lane boundary line probability calculating unit that calculates lane boundary line probability of the lane boundary line candidate;
a lane boundary line recognizing unit that recognizes a lane boundary line candidate of which the lane boundary line probability exceeds a predetermined threshold as a lane boundary line;
a solid object recognizing unit that recognizes a solid object in an image;
a hidden state detecting unit that detects a lane boundary line being hidden by the solid object; and
a lane boundary line probability correcting unit that when the lane boundary line being hidden by the solid object is detected, suppresses the lane boundary line probability in at least a part of an area outside of the hidden lane boundary line, compared to that when the lane boundary line being hidden by the solid object is not detected.

2. The lane boundary line recognition apparatus according to claim 1, wherein
when a lane boundary line being hidden by the solid object is temporarily detected and subsequently the lane boundary line being hidden is not detected, the lane boundary line probability correcting unit releases suppression of the lane boundary line probability.

3. The lane boundary line recognition apparatus according to claim 2, wherein
when a lane boundary line being hidden by a solid object is temporarily detected and subsequently the lane boundary line being hidden is not detected, the lane boundary line probability correcting unit increases the lane boundary line probability in at least a position of a hidden lane boundary line, compared to that when the lane boundary line being hidden by the solid object is not detected.

4. The lane boundary line recognition apparatus according to claim 3, further comprising:
a storage unit that stores a position of a hidden lane boundary line when the lane boundary line being hidden by the solid object is detected; and
a updating unit that updates the position of the hidden line based on a vehicle speed and a yaw rate of the own vehicle,
the lane boundary line probability correcting unit increasing the lane boundary line probability in a position of the lane boundary line updated by the updating unit, compared to that when the lane boundary line being hidden by the solid object is not detected.

5. The lane boundary line recognition apparatus according to claim 4, further comprising
a display unit that in a case where a lane boundary line being hidden by a solid object is detected, performs display based on the case.

6. The lane boundary line recognition apparatus according to claim 5, wherein
a display unit that in a case where a hidden lane boundary line cannot be recognized, performs display based on the case.

7. The lane boundary line recognition apparatus according to claim 1, wherein
when a lane boundary line being hidden by a solid object is temporarily detected and subsequently the lane boundary line being hidden is not detected, the lane boundary line probability correcting unit increases the lane boundary line probability in at least a position of a hidden lane boundary line, compared to that when the lane boundary line being hidden by the solid object is not detected.

8. The lane boundary line recognition apparatus according to claim 7, further comprising:
a storage unit that stores a position of a hidden lane boundary line when the lane boundary line being hidden by the solid object is detected; and
a updating unit that updates the position of the hidden line based on a vehicle speed and a yaw rate of the own vehicle,
the lane boundary line probability correcting unit increasing the lane boundary line probability in a position of the lane boundary line updated by the updating unit, compared to that when the lane boundary line being hidden by the solid object is not detected.

9. The lane boundary line recognition apparatus according to claim 1, further comprising
a display unit that in a case where a lane boundary line being hidden by a solid object is detected, performs display based on the case.

10. The lane boundary line recognition apparatus according to claim 9, wherein
a display unit that in a case where a hidden lane boundary line cannot be recognized, performs display based on the case.

11. A lane boundary line recognition method comprising:
imaging, by a lane boundary line recognition apparatus that is mounted to an own vehicle, a road surface ahead of the own vehicle and acquires an image;
extracting, by the lane boundary line recognition apparatus, edge points from the image;
extracting, by the lane boundary line recognition apparatus, a lane boundary line candidate based on the edge points;
calculating, by the lane boundary line recognition apparatus, lane boundary line probability of the lane boundary line candidate;
recognizing, by the lane boundary line recognition apparatus, a lane boundary line candidate of which the lane boundary line probability exceeds a predetermined threshold as a lane boundary line;
recognizing, by the lane boundary line recognition apparatus, a solid object in an image;
detecting, by the lane boundary line recognition apparatus, a lane boundary line being hidden by the solid object; and
when the lane boundary line being hidden by the solid object is detected, suppressing, by the lane boundary line recognition apparatus, the lane boundary line probability in at least a part of an area outside of the hidden lane boundary line, compared to that when the lane boundary line being hidden by the solid object is not detected.
